(19) United States
(12) Patent Application Publication
(10) Pub. No.: US 2008/0248207 A1
(43) Pub. Date: Oct. 9, 2008

(54) LIQUID RESIN COATING METHOD AND APPARATUS

(75) Inventor: Kazuma Sekiya, Ota-Ku (JP)

Correspondence Address: GREER, BURNS & CRAIN, 300 S WACKER DR, 25TH FLOOR, CHICAGO, IL, 60606, US

(73) Assignee: DISCO CORPORATION, Tokyo (JP)

(21) Appl. No.: 12/051,297

(22) Filed: Mar. 19, 2008

(30) Foreign Application Priority Data
Apr. 6, 2007 (JP) 2007-100610

(51) Int. Cl. B05D 1/40; B05D 3/12; B05B 13/02

(52) U.S. Cl. 427/346; 427/425; 118/320; 118/57

(57) ABSTRACT

A liquid resin-coating method in which a wafer (substrate) is concentrically held on a chuck table with a to-be-coated surface facing the upside. A slot die is arranged above and opposite to the wafer so that the slot of the slot die is allowed to correspond to the radius of the wafer. While the chuck table is rotated to bring the wafer into autorotation, resin is discharged from the slot to be coated on a to-be-coated surface of the wafer. The slot does not extend from the to-be-coated surface of the wafer, or if not so, the extension is extremely small. Thus, the amount of resin causing a loss is minimized.

### BACKGROUND OF THE INVENTION

1. Field of the Invention

The present invention relates to a liquid resin coating method and apparatus in which a slot die is used to coat the front or rear surface of a circular substrate with a liquid resin.

2. Description of the Related Art

Recent semiconductor device techniques have effectively used stacked packages such as MCP (multi-chip package) and SiP (system-in-package) in which a plurality of semiconductor chips are stacked and joined together, in order to achieve high-density and miniaturization. In such techniques, an adhesive layer formed on the rear surface of a chip is used to join chips together. Examples of such an adhesive generally include a resin-made glue film called a DAF (die attachment film). This DAF is stuck to the rear surface of a semiconductor wafer formed with a large number of semiconductor chips. When the semiconductor wafer is cut and divided along predetermined cutting lines into individual semiconductor chips, the DAF is simultaneously cut and stuck to the rear surfaces of the semiconductor chips.

In order to divide a semiconductor wafer into individual pieces, a plasma etching method is employed as well as a mechanical cutting method using a diamond blade or the like (see e.g. Japanese Patent Laid-Open No. 2006-128544). This method involves forming a resist film on the front or rear surface of a semiconductor wafer, removing portions of the resist film corresponding to the predetermined cutting lines thereof to expose the wafer, and etching the exposed portions with a plasma gas for removal. The resist film uses a novolac resin or the like. Formation of the resist film on the wafer employs a spin-coating method, a method of sticking film-like stuff or other methods. In the spin-coating method, resin is allowed to drop in the center of a rotating wafer and spread over the entire surface of the wafer by a centrifugal force for coating.

As described above, the fabrication process of the semiconductor chip may involve forming the resin coat on the semiconductor wafer. The resin coat is formed on the front or rear surface of a semiconductor wafer by sticking a resin film thereon or by coating a liquid resin thereon. Examples of resin-coating methods include a method in which a slot die is used to discharge resin from the slot of the slot die for coating, as well as the spin-coating method (see Japanese Patent Laid-Open No. Hei 9-285759).

The resin film mentioned above is usually formed like an elongate belt and wound like a roll for storage. Such a resin film is pulled out of a roll by a necessary length, then its adhesive face is stuck on a semiconductor wafer, and the resin film is cut out. Alternatively, a resin film is stuck that has previously been formed with cutting grooves having the same size as that of a wafer. Thus, the rectangular resin film protrudes from the outline of the semiconductor wafer, so that such protruding portions are left. In other words, the excess portions are produced around the semiconductor wafer, which leads to losses in view of material and of costs.

On the other hand, in the case where a liquid resin is coated by a spin-coating method, it is necessary to drop an amount of resin in excess of an amount of resin that is actually stuck to a to-be-coated surface to form a film. Also the scattering resin causes a loss. On this point, it is considered that the coating method using the slot die is less liable to cause a loss because of no scattering resin. However, since the slot die is moved linearly with respect to the circular semiconductor wafer for coating, the resin discharged from a portion of the slot away from a surface (to-be-coated surface) to be coated with resin is not coated in the moving process, which causes a loss.

### SUMMARY OF THE INVENTION

It is an object of the present invention, therefore, to provide a liquid resin coating method and apparatus in which when a liquid resin is coated on the front or rear surface of a circular substrate such as a semiconductor wafer or the like, resin usage in excess of an amount of resin that is actually coated on a to-be-coated surface can be minimized to consequently prevent occurrence of losses in view of material and of costs.

In accordance with an aspect of the present invention, there is provided a method of coating one surface of a circular substrate with a liquid resin discharged from a slot of a slot die, the method including: a substrate-holding step in which holding means holds the substrate with the one surface exposed; a slot die arrangement step in which the slot die is used whose slot has a length equal to or in excess of the radius of the substrate and the slot die is arranged to face the substrate in such a manner that the slot is located at a position corresponding to at least the radius of the substrate so as to be parallel to the substrate held by the holding means; and a liquid resin-coating step in which a liquid resin is discharged from the slot of the slot die so as to be coated on the one surface of the substrate while relatively rotating the holding means and the slot die around a central axis, as a rotational axis, of the substrate held by the holding means.

In the method according to the aspect of the present invention, the slot of the slot die is parallelly arranged to correspond to the radius of the substrate held by the holding means. The fact that the slot is arranged to correspond to the radius of the substrate means a configuration where if the length of the slot is equal to the radius of the substrate, the slot extends from the central axis of the substrate to the outer circumferential edge of the substrate. Specifically, one end of the slot coincides with the central axis of the substrate and the other end coincides with the outer circumferential edge thereof. If the slot is slightly longer than the radius of the substrate, there are three configurations as follows: A first one is that one end of the slot coincides with the central axis of the substrate and the other end outwardly extends from the outer circumferential edge of the substrate. A second one is that inversely the one end of the slot passes the central axis of the substrate and the other end coincides with the outer circumferential edge of the substrate. A third one is that both ends of the slot pass the central axis and outer circumferential edge, respectively, of the substrate.

In such a state where the slot is arranged to correspond to the radius of the substrate, if the holding means and the slot die are turned with respect to the substrate, the slot turns clockwise with respect to the one surface (to-be-coated surface) of the substrate. While a liquid resin is discharged from the slot, the slot is turned by one rotation or more with respect to the substrate. Thus, the liquid resin is coated over the entire one surface (to-be-coated surface) of the substrate.

The present invention embraces a configuration where the slot of the slot die has a length equal to or in excess of the diameter of the substrate. In such a configuration, the fact that the slot is arranged to correspond to the radius of the substrate means that if the slot has a length equal to the diameter of the substrate, the slot is arranged so as to pass the central axis of the substrate and to have both ends terminating at the outer circumferential edge. If the slot has a length in excess of the diameter of the substrate, the slot passes the central axis of the substrate and has both end located outwardly of the outer circumferential edge of the substrate or has only one end coincident with the outer circumferential edge. As described above, in the configuration where the slot of the slot die has a length equal to or in excess of the diameter of the substrate, if the slot die is turned by 180°, i.e., by a semicircle, the entire to-be-coated surface can be coated with resin.

In the configuration where the slot is arranged to correspond to the radius of the substrate and specifically to have a length equal to the radius or diameter of the substrate, the resin discharged from the slot does not protrude from the outer circumferential edge of the substrate. Even if the excess protrudes from the outer circumferential edge of the substrate, the resin is discharged to cover the entire to-be-coated surface while the amount of the excess is suppressed to an extremely small level. In other words, the resin is less liable to be discharged to a portion other than the to-be-coated surface so that no loss of resin usage virtually occurs in this case. In the configuration where the slot has a length greater than the radius or diameter of the substrate but does not extend outwardly from the outer circumferential edge of the substrate, the resin is less liable to be discharged from the slot to a portion other than the to-be-coated surface so that no loss of resin usage virtually occurs. Incidentally, a necessary amount of resin applied to the substrate can optionally be adjusted based on the amount of resin discharged from the slot or on the relative rotation number of the slot.

In the configuration where the slot extends outwardly from the outer circumferential edge of the substrate, the excess resin corresponding to the outward extension of the slot is discharged to cause a loss. However, the slot is adjusted to minimize the excess length, thereby minimizing resin usage.

Incidentally, in general the amount of resin discharged from the slot of the slot die does not vary, namely, is uniform, in the longitudinal direction of the slot. However, the circumferential velocity of the slot rotating with respect to the substrate is slow on the central side of the wafer and fast on the outer circumferential side. An amount of coating may progressively be smaller as it goes from the central side to the outer circumferential side. This causes coating variations where the resin film thickness slants in the radial direction. In other words, the resin film thickness has a falling gradient from the central side of the substrate toward the outer circumferential side thereof. Such a phenomenon is a problem to be solved when the resin film thickness is made uniform. This problem is solved by applying ultrasonic vibration via the holding means to the substrate held by the holding means in the middle of the liquid resin coating step or at a stage after this coating step and before the curing of the resin. Specifically, the application of ultrasonic vibration to the substrate causes the resin coated to flow and have a uniform film thickness, eliminating coating variations.

In accordance with another aspect of the present invention, there is provided a liquid resin coating apparatus including: holding means for holding a circular substrate with one surface of the substrate exposed; a slot die which is arranged parallel to and oppositely to the substrate in such a manner that a slot adapted to discharge a liquid resin has a length equal to or in excess of the radius of the substrate and is arranged parallel to the substrate held by the holding means so as to correspond to the radius of the substrate; and rotation-drive means for relatively rotating the holding means and the slot die around a central axis of the substrate. Preferably, this coating apparatus further includes ultrasonic vibration applying means for applying ultrasonic vibration to the holding means.

According to the present invention, the slot die is used that has a slot with a length equal to or in excess of the radius of the circular substrate and resin is coated on the substrate while relatively turning the slot with respect to the substrate around the central axis of the substrate as a rotational axis. This makes it possible to minimize resin usage in excess of the amount of resin actually coated on the to-be-coated surface. As a result, there is provided an effect of preventing occurrence of a loss in view of material and of costs.

The above and other objects, features and advantages of the present invention and the manner of realizing them will become more apparent, and the invention itself will best be understood from a study of the following description and appended claims with reference to the attached drawings showing some preferred embodiments of the invention.

### BRIEF DESCRIPTION OF THE DRAWINGS

FIG. 1 is a perspective view of a coating apparatus according to an embodiment of the present invention;

FIG. 2 is a lateral view illustrating a mechanism for rotating a chuck table of the coating apparatus illustrated in FIG. 1;

FIG. 3 is a perspective view illustrating a slot die lifting and lowering mechanism and chuck table of the coating apparatus illustrated in FIG. 1; and

FIGS. 4A to 4G are schematic views illustrating the positional relationships between a wafer and a slot of the slot die.

### DETAILED DESCRIPTION OF THE PREFERRED EMBODIMENT

Embodiment of the present invention will hereinafter be described with reference to the drawings.

### [1] Configuration of a Coating Apparatus

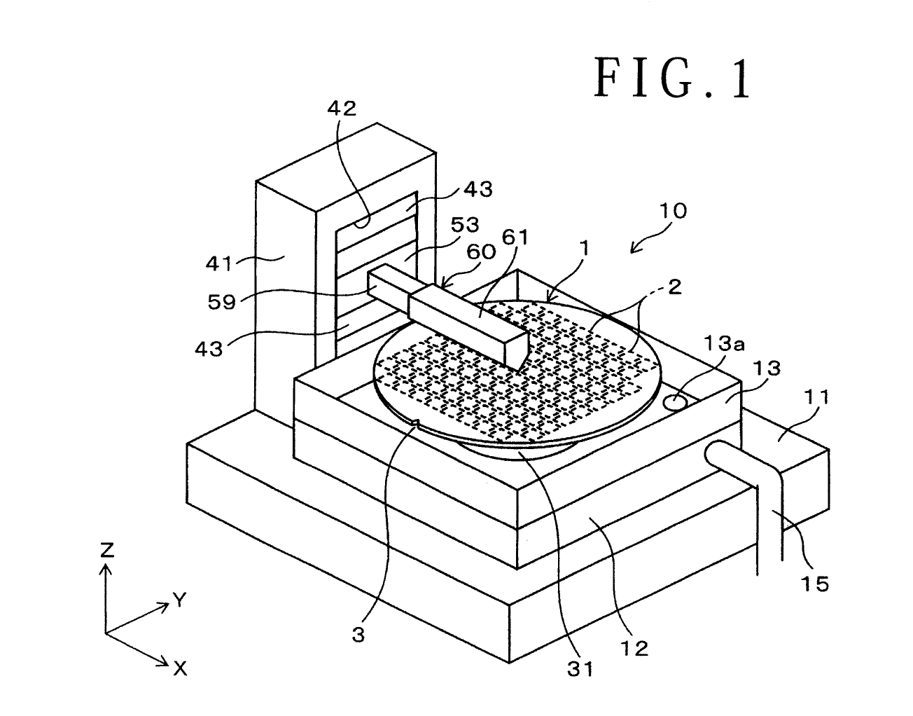

FIG. 1 illustrates a liquid resin coating apparatus according to an embodiment of the present invention. This coating apparatus 10 is used to coat a predetermined liquid resin on the front or rear surface of a disklike substrate. This liquid resin is an adhesive-purpose resin which becomes a DAF mentioned earlier, or a resin used to form a resist film and is coated on the front or rear surface of the substrate depending on a purpose and use application. The present embodiment exemplifies a semiconductor wafer (hereinafter abbreviated to the wafer) 1 as the substrate. The wafer 1 is formed on its front surface with a large number of chips 2 sectioned in a lattice-like manner. The chip 2 is formed on its front surface with electronic circuits not shown such as an IC (Integral Circuit) or LSI (Large Scale Integration). In FIG. 1, the wafer 1 lies with its rear surface side up; therefore, the chips 2 are illustrated with broken lines. A V-shaped notch 3 is formed at a predetermined position on the circumferential surface of the wafer 1 to indicate the crystal orientation of the semiconductor.

Incidentally, X- and Y-directions indicate horizontal directions perpendicular to each other and a Z-direction indicates a vertical direction perpendicular to the horizontal plane.

The coating apparatus 10 has a rectangular base 11 on which a drainage pan 13 is mounted via a support frame 12. The support frame 12 and the drainage pan 13 are rectangular and the inside of the support frame 12 is defined as a space. A drainage pipe 15 is inserted into the support frame 12 from the outside and connected to a drainage port 13a formed at a corner of the drainage pan 13. The wafer 1 is horizontally and turnably held inside the drainage pan 13. Water is contained in the drainage pan 13 to catch dropping resin that has not been coated. This water is drained from the drainage port 13a to a waste disposal plat or the like at the appropriate time by opening a valve provided in the middle of the drainage pipe 15.

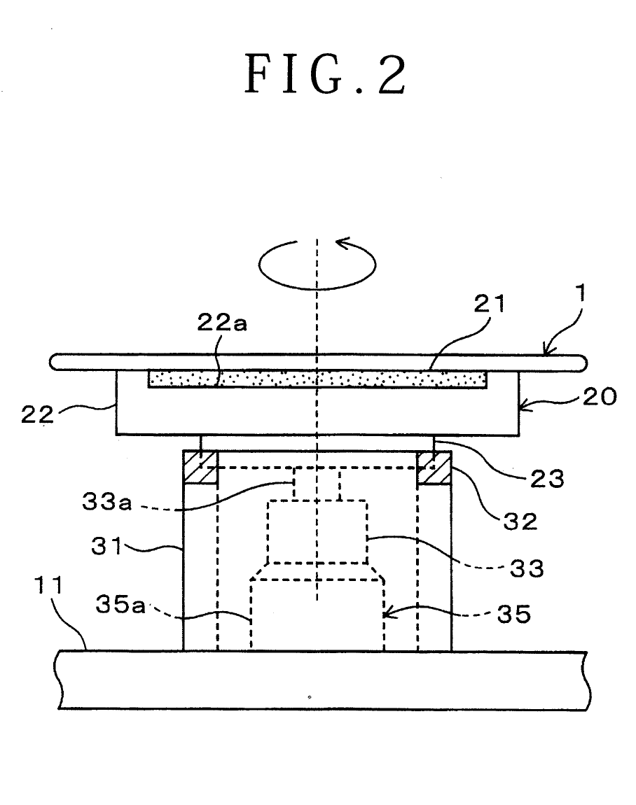

The wafer 1 is concentrically held on the upper surface of the disklike chuck table 20 shown in FIG. 2 so as to expose a surface to be coated with resin. The chuck table 20 is of a well-known vacuum chuck type in which the horizontal upper surface is formed with a porous suction area 21 adapted to suck and hold the wafer 1. The suction area 21 is fitted into a shallow recess portion 22a formed in the upper surface of a disklike frame body 22 forming the outer shape of the chuck table 20. The annular upper surface of the frame body 22 surrounding the suction area 21 is made flush with the upper surface of the suction area 21. The chuck table 20 has a table base 23 at the central bottom surface thereof.

A cylindrical post 31 is provided to extend upright from the central portion of the base 11 as shown in FIG. 2. The upper end portion of the post 31 passes through the bottom portion of the drainage pan 13 and such a through-portion is sealed to prevent water from leaking therefrom. The table base 23 of the chuck table 20 is supported by the upper end of the post 31 via a bearing 32 for rotation around the Z-direction as a rotational axis. A drive shaft 33a of a motor 33 housed in the post 31 is connected to the central bottom surface of the table base 23. The motor 33 is actuated to rotate the chuck table 20. The motor 33 is secured from above to the housing 35a of ultrasonic vibratory equipment 35 mounted on the base 11 and in the post 31.

An ultrasonic oscillator not shown is housed inside the housing 35a and connected to the drive shaft 33a of the motor 33. With such a configuration, the ultrasonic oscillator of the ultrasonic vibratory equipment 35 is actuated to apply ultrasonic vibration to the wafer 1 via the drive shaft 33a of the motor 33 and via the chuck table 20. The wafer concentrically sucked and held on the chuck table 20 has a diameter greater than that of the chuck table 20 and is sized to be received inside the drainage pan 13.

As shown in FIG. 1, a column 41 is provided at one end of the X-direction and on the periphery of the drainage pan 13 so as to extend upright from the base 11. A slot die 60 which applies resin to the wafer 1 is provided on the front surface (the drainage pan 13 side) of the column 41 so as to be movable upward and downward as shown in FIG. 1. The slot die 60 is lifted and lowered by a ball screw type lifting and lowering mechanism 50.

The lifting and lowering mechanism 50 includes a pair of linear guides 51 provided in the column 41 so as to be spaced apart from each other in the Y-direction and extend in the Z-direction; and a ball screw 55 provided between the linear guides 51 so as to extend in the Z-direction. Sliders 52 are slidably mounted to the respective linear guides 51 and are connected to each other by a slider base 53. A block 54 is secured to the rear surface of the slider base 53 and a ball screw 55 passes through the block 54 so as to be threadedly engaged therewith. The ball screw 55 is turned by a motor not shown to lift or lower the block 54 and the slider base 53 integral with the block 54 along the linear guides 51 in response to the turning direction thereof.

The column 41 is formed with an opening 42 in the front surface as shown in FIG. 1. This opening 42 is closed with slide covers 43 which cover the lifting and lowering mechanism 50 except the slider base 53. The respective slide covers 43 are attached to the upper and lower ends of the slider base 53 and configured to elongate and contract along with the upward and downward movement of the slider base 53.

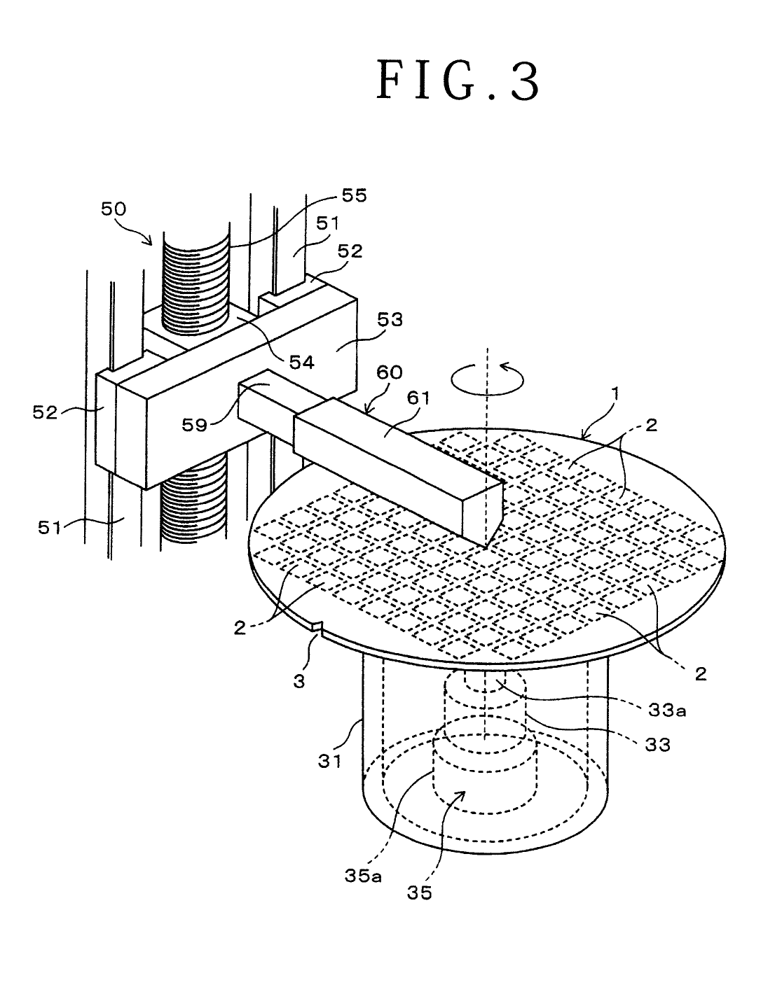

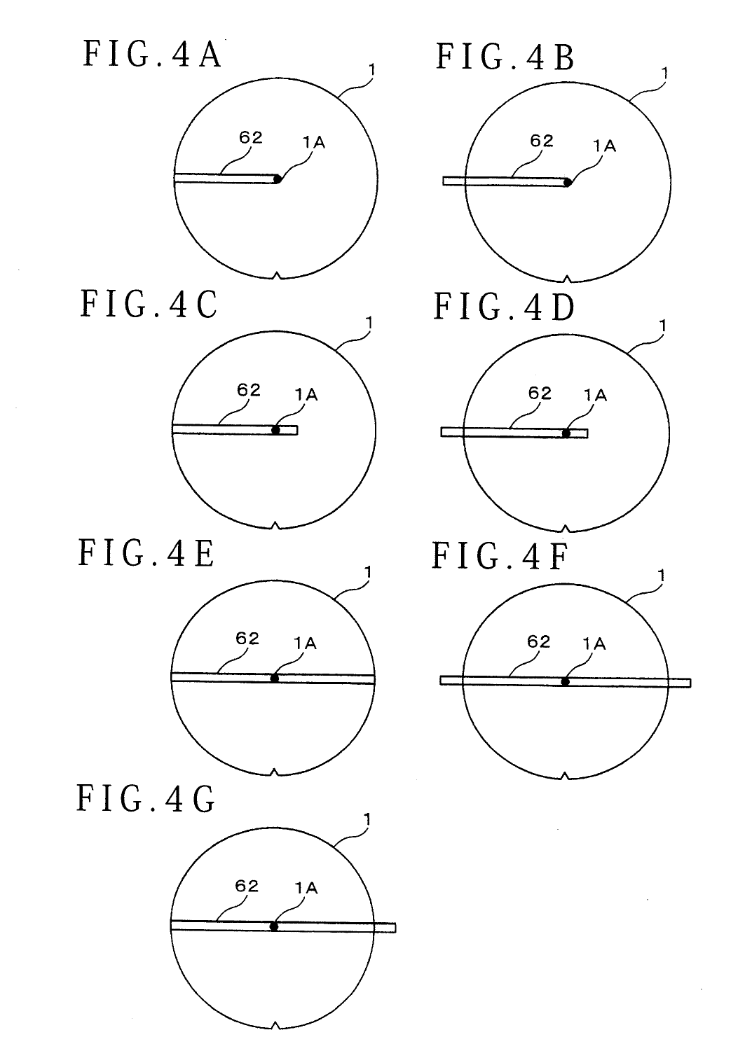

As shown in FIG. 3, the slot die 60 is attached to the front surface of the slider base 53 via an arm 59 extending in the X-direction, the slider base 53 constituting part of the lifting and lowering mechanism 50. The slot die 60 is mainly composed of a die block 61 formed like a bar with a predetermined length. The die block 61 is shaped in a pentagon, in cross-section, in which the lower side of a rectangle protrudes triangularly. The die block 61 is formed with a slot 62 (see FIGS. 4A to 4G), a resin-discharge port, at the projecting edge of the lower end extending like a ridge in the longitudinal direction. This slot 62 has a length approximately equal to the full length of the die block 61. The slot 62 is adapted to discharge resin in strip form. A coating member such as a blade or a roller is attached to the die block 61 so as to be disposed on one side of the slot 62 for uniformly pressing the resin onto the to-be-coated surface.

The slot die 60 configured as above is attached to the leading end of the arm 59 in such a manner that the longitudinal direction of the die block 61 is made parallel to the X-direction and is lifted and lowered along with the arm 59 by the lifting and lowering mechanism 50. The slot die 60 is provided in the die block 61 with resin supply means, not shown, for supplying a liquid resin. This resin supply means is designed to be able to follow the upward and downward movement of the slot die 60.

The slot die 60 is lowered, being brought into close to and opposed parallel to the wafer 1 held on the chuck table 20, and is stopped at a height where the distance between the to-be-coated surface of the wafer 1 and the slot 62 becomes appropriate for resin coating. In this coating state, the slot 62 of the slot die 60 extending in the X-direction is arranged to extend in the radial direction of the chuck table 20. In addition, the leading end of the slot 62 reaches the rotational centerline of the chuck table 20 and the proximal end thereof (the end close to the arm 59) reaches the outer circumferential edge of the wafer 1 concentrically held on the chuck table 20.

In this way, the slot 62 of the slot die 60 is set to have the length and arrangement so that it may correspond to the radius of the wafer 1 concentrically held on the chuck table 20. The indispensable condition of this setting is to provide the following configuration as shown in FIG. 4A: The length of the slot 62 is equal to the radius of the wafer 1. The leading end of the slot 62 coincides with the central axis (the rotational center of the chuck table 20) 1A of the wafer 1 and the proximal end coincides with the outer circumferential edge of the wafer 1.

Alternatively, the following three configurations may be conceivable in which the slot 62 is slightly longer than the radius of the wafer 1. A first configuration is such that the leading end of the slot 62 coincides with the central axis 1A of the wafer 1 and the proximal end externally extends from the outer circumferential edge of the wafer 1, as shown in FIG. 4B. A second one is such that the leading end of the slot 62 passes the central axis 1A of the wafer 1 and the proximal end coincides with the outer circumferential edge of the wafer 1 as shown in FIG. 4C. A third one is such that both respect ends of the slot 62 pass the central axis 1A and outer circumferential edge of the wafer 1 as shown in FIG. 4D.

### [2] Operation of the Coating Apparatus

The coating apparatus 10 of the present embodiment is configured as above. The operation of the coating apparatus 10 is next described. This operation embodies the coating method of the present invention. At first, the chuck table 20 is previously vacuum-operated and then the wafer 1 is concentrically placed on the chuck table 20 so as to face up and expose the to-be-coated surface (front or rear surface) needed to be coated with resin. In FIGS. 1 and 3, the rear surface, which is opposite with the front surface formed with a large number of chips 2, is the to-be-coated surface. The wafer 1 is suck and held on the suction area 21 of the chuck table 20 simultaneously with the placement (a substrate-holding step).

Next, the slot die 60 is lowered by the lifting and lowering mechanism 50 and stopped at a height where the slot 62 is spaced at an appropriate interval apart from the to-be-coated surface of the wafer 1 (a slot die arrangement step). Subsequently, the chuck table 20 is rotated to bring the wafer 1 into autorotation and then a liquid resin is supplied to the slot die 60. Incidentally, the rotational direction of the chuck table 20 is such that the coating member (a blade or roller) is located on the downstream side of the slot 62 rotating with respect to the chuck table 20.

The resin is discharged under pressure from the slot 62 in strip form and uniformly coated on the to-be-coated surface of the rotating wafer 1 while being pressed against the to-be-coated surface by the coating member (a liquid resin-coating step). The resin is coated on the entire to-be-coated surface while the wafer 1 is rotated once. However, the wafer may be rotated a plurality of times as necessary depending on the conditions such as coating thickness and the like. The rotational speed of the chuck table 20 is e.g. 1 to 10 rpm; however, it is appropriately adjusted depending on the viscosity of resin to be coated or coating thickness.

When the necessary thickness of the resin is obtained, the discharge of the resin from the slot 62 is stopped and the rotation of the chuck table 20 is stopped. Then, the slot die 60 is lifted to a withdrawal position and the resin-coating step is ended. During the coating of the resin, extra resin may drop from the outer circumferential edge of the wafer 1 in some cases. The dropping resin is caught by the water in the drainage pan 13 and such water is appropriately drained. This makes it possible to smoothly discharge the dropping resin even if high-viscous resin is used. The wafer 1 that is coated with resin to have a necessary resin film is subjected to post-processing such as a resin film cure treatment or the like. The post-processing is subsequently performed on the chuck table 20. Alternatively, the wafer 1 is picked up from the chuck table 20 and conveyed to a predetermined site where it is subjected to the post-processing.

It has been described that the resin is uniformly coated on the wafer 1. However, the circumferential velocity of the slot 62 rotating with respect to the wafer 1 is slow on the central side of the wafer 1 and fast on the outer circumferential side. Therefore, sometimes an amount of coating may progressively be smaller as it goes from the central side to the outer circumferential side. This causes coating variations where the resin film thickness slants in the radial direction. In particular, as shown in FIGS. 4C and 4D, in the cases where the leading end of the slot 62 extends from the central axis of the wafer 1, an area corresponding to such an extending portion is duplicately coated with the resin to increase the film thickness, which may cause coating variations in some cases. To eliminate such coating variations, the ultrasonic vibratory equipment 35 is actuated at least in the middle of coating the resin during the rotation of the chuck table 20 or just after the end of the coating. This applies ultrasonic vibrations to the wafer 1 to allow the coated resin to flow and make the film thickness uniform, eliminating the coating variations.

### [3] Function and Effect of the Present Embodiment

According to the present embodiment, in the configuration where the slot 62 of the slot die 60 is arranged to corresponds to the radius of the wafer 1, specifically, to have a length equal to the radius of the wafer 1 as shown in FIG. 4A, the resin discharged from the slot 62 will not protrude from the outer circumferential edge of the wafer 1. Alternatively, even if an excess of the resin discharged is pressed out to protrude from the circumferential edge of the wafer 1, the amount of the excess is kept at an extremely small level while the resin is discharged over the entire to-be-coated surface. In short, the resin is less liable to be discharged to any portion other than the to-be-coated surface so that no loss of resin usage virtually occurs in this case. Even in the case where the slot 62 has a length greater than the radius of the wafer 1 and in the configuration where the slot 62 does not extend outwardly from the outer circumferential edge of the wafer 1 as shown in FIG. 4C, also the resin to be discharged from the slot 62 is less liable to be discharged to any portion other than the to-be-coated surface, resulting in almost no loss of resin usage.

As shown in FIGS. 4B and 4D, in the configuration where the slot 62 has a length greater than the radius of the wafer 1 and extends outwardly from the outer circumferential edge of the wafer 1, the excess resin corresponding to the outward extension of the slot 62 is discharged to cause a loss. However, the slot 62 is adjusted to reduce the excess length thereof relative to the radius of the wafer 1 as much as possible, thereby minimizing the resin usage. The application of ultrasonic vibrations to the wafer 1 as described earlier in the present embodiment can eliminate the coating variations occurring due to the difference in the circumferential velocity of the slot die 60.

In the embodiment described above, the slot 62 of the slot die 60 is arranged to correspond to the radius of the wafer 1, specifically, to have a length equal to or slightly greater than the radius of the wafer 1. However, the present invention embraces a configuration where the slot 62 is arranged to correspond to the diameter of the wafer 1, specifically, to have a length equal to or greater than the diameter of the wafer 1. To arrange the slot 62 to correspond to the radius of the wafer 1 in such a configuration, if the slot 62 has a length equal to the diameter of the wafer 1, the slot 62 is arranged such that it passes the central axis 1A of the wafer 1 and both ends thereof terminate at the outer circumferential edge of the wafer 1 as shown in FIG. 4E. If the slot 62 has a length in excess of the diameter of the wafer 1, two configurations is provided as follows: one is that the slot 62 passes the central axis 1A of the wafer 1 and both ends thereof extends outwardly from the outer circumferential edge of the wafer 1 as shown in FIG. 4F. The other is that only one end of the slot 62 coincides with the outer circumferential edge of the wafer 1 and the other end extends outwardly from the outer circumferential edge thereof as shown in FIG. 4G.

As described above in the configuration where the slot 62 of the slot die 60 has a length equal to or greater than the diameter of the wafer 1, the slot die 60 is turned by 180°, i.e., by a semicircle with respect to the wafer 1 to coat the entire to-be-coated surface with resin. The rotation number of the slot die 60 depends on the resin-coating thickness or the like. If the length of the slot 62 is made to correspond to the diameter of the wafer 1, the rotation number of the slot die 60 can be reduced to a half compared with the case where the slot 62 has a length corresponding to the radius of the wafer 1 as in the embodiment described earlier. This provides advantages such as reduced working time and energy saving.

The present invention is not limited to the details of the above described preferred embodiments. The scope of the invention is defined by the appended claims and all changes and modifications as fall within the equivalence of the scope of the claims are therefore to be embraced by the invention.

What is claimed is:

1. A method of coating one surface of a circular substrate with a liquid resin discharged from a slot of a slot die, the method comprising:
a substrate-holding step in which holding means holds the substrate with the one surface exposed;
a slot die arrangement step in which the slot die is used whose slot has a length equal to or in excess of the radius of the substrate and the slot die is arranged to face the substrate in such a manner that the slot is located at a position corresponding to at least the radius of the substrate so as to be parallel to the substrate held by the holding means; and
a liquid resin-coating step in which a liquid resin is discharged from the slot of the slot die so as to be coated on the one surface of the substrate while relatively rotating the holding means and the slot die around a central axis, as a rotational axis, of the substrate held by the holding means.

2. The method according to claim 1, wherein ultrasonic vibration is applied via the holding means to the substrate held by the holding means in the middle of or after the liquid resin-coating step.

3. A liquid resin coating apparatus comprising:
holding means for holding a circular substrate with one surface of the substrate exposed;
a slot die which is arranged parallel to and oppositely to the substrate in such a manner that a slot adapted to discharge a liquid resin has a length equal to or in excess of the radius of the substrate and is arranged parallel to the substrate held by the holding means so as to correspond to the radius of the substrate; and
rotation-drive means for relatively rotating the holding means and the slot die around a central axis of the substrate.

4. The liquid-resin coating apparatus according to claim 3, further comprising ultrasonic vibration applying means for applying ultrasonic vibration to the holding means.
